(19) United States
(12) Patent Application Publication
(10) Pub. No.: US 2025/0252294 A1
(43) Pub. Date: Aug. 7, 2025

(54) MACHINE LEARNING-BASED DETECTION OF ANOMALOUS OBJECT BEHAVIOR IN A MONITORED PHYSICAL ENVIRONMENT

(71) Applicant: Dell Products L.P., Round Rock, TX (US)

(72) Inventors: Theodore R. Grevers, Milford, MA (US); Roya Alizadeh, Markham (CA); John Cardente, Milford, MA (US)

(21) Appl. No.: 18/431,069

(22) Filed: Feb. 2, 2024

(51) Int. Cl. G06N 3/0464

(52) U.S. Cl. CPC G06N 3/0464

(57) ABSTRACT

Techniques are provided for machine learning-based detection of anomalous object behavior in a monitored physical environment. One method includes obtaining activity maps comprising data characterizing objects of a respective object type within a monitored physical environment; applying the activity maps to a machine learning model trained to generate one or more predicted activity maps; comparing the one or more predicted activity maps to corresponding activity maps; and, in response to a result of the comparison indicating anomalous object behavior, initiating at least one automated action. A given activity map may comprise multiple cells, wherein a given cell is mapped to a corresponding portion of the monitored physical environment. The given activity map may correspond to a particular object type and the given cell may comprise aggregated data characterizing objects of the particular object type in the given cell.

### BACKGROUND

In many settings, incidents may involve workers, the equipment used by such workers (e.g., machinery or tools) and/or the materials used by such workers. The workers, equipment and/or the materials can be monitored and deviations from expected behavior may be identified as potentially anomalous behavior.

### SUMMARY

Illustrative embodiments of the disclosure provide techniques for machine learning-based detection of anomalous object behavior in a monitored physical environment. One method includes obtaining a plurality of activity maps comprising data characterizing one or more objects of at least one object type within a monitored physical environment; applying one or more of the plurality of activity maps to a machine learning model trained to generate at least one predicted activity map, wherein the machine learning model is implemented using at least one hardware device; comparing the at least one predicted activity map to corresponding ones of the plurality of activity maps; and in response to a result of the comparison indicating anomalous object behavior, initiating at least one automated action.

Illustrative embodiments can provide significant advantages relative to conventional techniques for detection of anomalous behavior. For example, challenges associated with detecting anomalous behavior are overcome in one or more embodiments by (i) applying activity maps, characterizing objects within a monitored physical environment, to a machine learning model trained to generate one or more predicted activity maps and (ii) identifying anomalous object behavior using the one or more predicted activity maps.

These and other illustrative embodiments described herein include, without limitation, methods, apparatus, systems, and computer program products comprising processor-readable storage media.

### BRIEF DESCRIPTION OF THE DRAWINGS

FIG. 1 shows an information processing system configured for machine learning-based detection of anomalous object behavior in a monitored physical environment in an illustrative embodiment;

FIG. 2 illustrates a monitored physical environment of FIG. 1 in further detail in an illustrative embodiment;

FIG. 3 illustrates the anomaly detection module of FIG. 2 in further detail in an illustrative embodiment;

FIG. 4 is a flow diagram of a machine learning process in an illustrative embodiment;

FIG. 5 illustrates a generation of activity maps characterizing sensor data associated with various monitored objects in a monitored physical environment in an illustrative embodiment;

FIG. 6 illustrates an activity map set sequence in an illustrative embodiment;

FIG. 7 is a flow diagram illustrating an exemplary implementation of a process for machine learning-based detection of anomalous object behavior in a monitored physical environment in an illustrative embodiment;

FIG. 8 illustrates a training of a machine learning model to predict activity map sets in an illustrative embodiment;

FIG. 9 illustrates a detection of anomalous object behavior in a monitored physical environment using a trained machine learning model in an illustrative embodiment;

FIG. 10 illustrates an exemplary architecture for a machine learning model configured to detect anomalous object behavior in a monitored physical environment in an illustrative embodiment;

FIG. 11 is a flow diagram illustrating an exemplary implementation of a process for machine learning-based detection of anomalous object behavior in a monitored physical environment in an illustrative embodiment;

FIG. 12 illustrates an exemplary processing platform that may be used to implement at least a portion of one or more embodiments of the disclosure comprising a cloud infrastructure; and

FIG. 13 illustrates another exemplary processing platform that may be used to implement at least a portion of one or more embodiments of the disclosure.

### DETAILED DESCRIPTION

Illustrative embodiments will be described herein with reference to exemplary computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

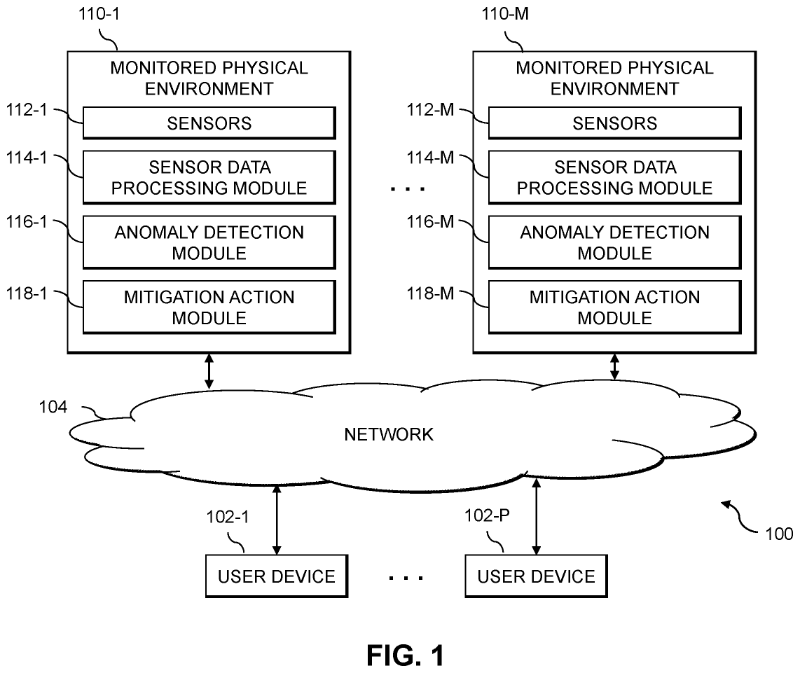

FIG. 1 shows a computer network (also referred to herein as an information processing system) 100 configured in accordance with an illustrative embodiment. The computer network 100 comprises a plurality of user devices 102-1, . . . 102-P, collectively referred to herein as user devices 102. The user devices 102 are coupled to a network 104, where the network 104 in this embodiment is assumed to represent a sub-network or other related portion of the larger computer network 100. Accordingly, elements 100 and 104 are both referred to herein as examples of “networks,” but the latter is assumed to be a component of the former in the context of the FIG. 1 embodiment. Also coupled to network 104 are monitored physical environments 110-1, . . . 110-M (collectively referred to herein as monitored physical environments 110). The monitored physical environments 110 may comprise, for example, an edge environment, such as a construction environment, a manufacturing environment, an industrial environment or a fulfillment center, among others. The monitored physical environments 110 may be located in one or more geographic locations.

The user devices 102 may comprise, for example, servers and/or portions of one or more server systems, as well as devices such as mobile telephones, laptop computers, tablet computers, desktop computers or other types of computing devices. Such devices are examples of what are more generally referred to herein as “processing devices.” Some of these processing devices are also generally referred to herein as “computers.”

The user devices 102 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

Also associated with the user devices 102 are one or more input-output devices, which illustratively comprise keyboards, displays or other types of input-output devices in any combination. Such input-output devices can be used, for example, to support one or more user interfaces to the user devices 102, as well as to support communication between the one or more monitored physical environments 110 and/or other related systems and devices not explicitly shown.

The network 104 is assumed to comprise a portion of a global computer network such as the Internet, although other types of networks can be part of the computer network 100, including a wide area network (WAN), a local area network (LAN), Narrowband-IoT (NB-IoT), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

The monitored physical environment 110-1 includes one or more sensors 112-1, a sensor data processing module 114-1, an anomaly detection module 116-1 and a mitigation action module 118-1. In at least some embodiments, the one or more sensors 112 may be embedded in, attached to (e.g., sensors wearable by humans or animals), or otherwise associated with certain object types, such as people, materials and equipment. While this disclosure describes three exemplary types of objects (e.g., people, materials and equipment), the disclosed techniques can be extended to consider more or less object types, as would be apparent to a person of ordinary skill in the art based on the present disclosure.

The sensors 112, in some embodiments, may correspond to a sensor array comprising one or more IoT (Internet of Things) sensors. The IoT sensors may alternatively be referred to as IoT edge sensors and include, but are not limited to, sensors, actuators or other devices that produce information and/or are responsive to commands to measure, monitor and/or control the environment that they are in. Sensors within the scope of this disclosure may operate automatically and/or may be manually activated. In general, the type, number, location, and combination of sensors can be based on considerations including, but not limited to, the object types, the types of anomalies most likely to be encountered in a given monitored physical environment 110, the proximity of potential anomaly sources, and the amount of time needed to implement one or more mitigative actions once an anomaly has been identified.

In some embodiments, the sensor data processing module 114 transforms the sensor data from the sensors 112 into a format that can be consumed by the anomaly detection module 116 (e.g., by compressing the sensor data and/or reducing noise in the sensor data, as discussed further below). Sensor data is often small so compression may not be needed in some implementations. The compression may employ one or more frameworks that provide for exporting machine learning models to form factors, such as mobile and/or embedded devices.

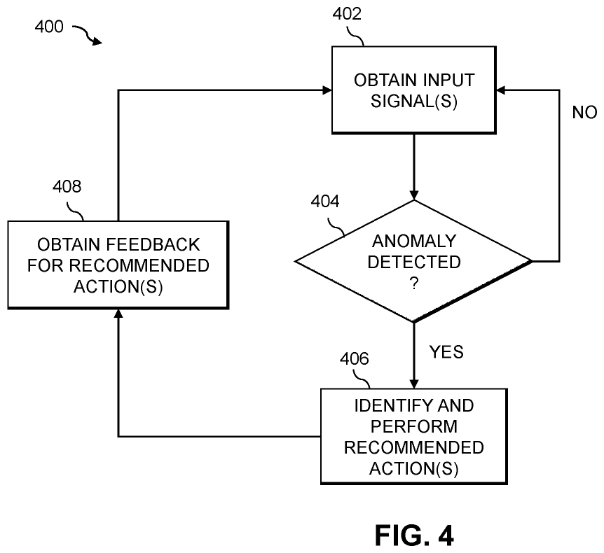

The anomaly detection module 116, in some embodiments, employs one or more machine learning models that analyze activity maps based at least in part on the sensor data and detect potential anomalous behavior associated with one or more objects. Additionally, the anomaly detection module 116 can decide on at least one automated action to at least partially mitigate such anomalous behavior, as described in more detail below in conjunction with FIG. 4, for example.

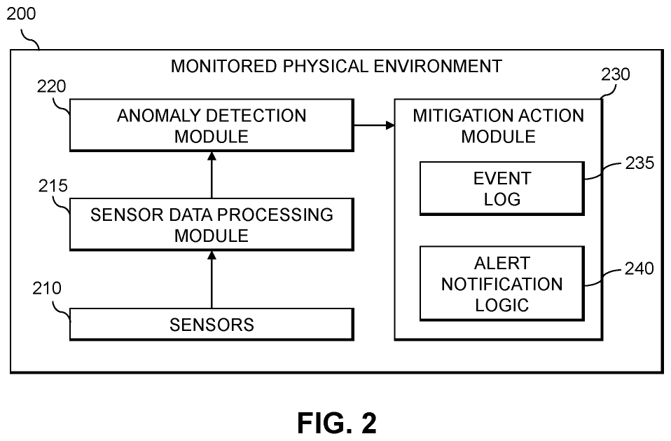

Non-limiting examples of sensors 112 include, but are not limited to, accelerometers, gyroscopes, cameras, light sensors, humidity sensors, vibration sensors, smoke sensors, door or window open/close sensors, temperature sensors and/or motion sensors, as discussed further below in conjunction with FIG. 2, for example. The foregoing and/or other sensors can be employed in any combination, type, and number.

Generally, the sensors 112 may be collocated in some embodiments with the monitored physical environment 110-1 in order to detect actual and/or potential anomalous behavior with respect to one or more objects.

As noted above, the monitored physical environment 110-1 may also include mitigation action module 118-1. Generally, the mitigation action module 118-1 performs at least one automated action in order to mitigate detected anomalies. For example, an automated action may include generating an alert or a notification upon detection of anomalous behavior, and/or providing at least a portion of the sensor data associated with the anomalous behavior to at least one designated system associated with the monitored physical environment 110-1.

In the FIG. 1 embodiment, the representative monitored physical environment 110-1 can have at least one associated database (not explicitly shown in FIG. 1) configured to store sensor data obtained from one or more sensors 112-1. Databases associated with one or more of the monitored physical environments 110, in some embodiments, can be implemented using one or more corresponding storage systems. Such storage systems can comprise any of a variety of different types of storage including network-attached storage (NAS), storage area networks (SANs), direct-attached storage (DAS) and distributed DAS, as well as combinations of these and other storage types, including software-defined storage.

Each of the other monitored physical environments 110 may be implemented in a similar manner as monitored physical environment 110-1, for example. Additionally, each of the one or more monitored physical environments 110 in the FIG. 1 embodiment is assumed to be implemented using at least one processing device. Each such processing device generally comprises at least one processor and an associated memory, and implements one or more functional modules for controlling certain features of the monitored physical environments 110. More particularly, the one or more monitored physical environments 110 in this embodiment can each comprise a processor coupled to a memory and a network interface.

The processor illustratively comprises a microprocessor, a central processing unit (CPU), a graphics processing unit (GPU), a tensor processing unit (TPU), a microcontroller, an application-specific integrated circuit (ASIC), a field-programmable gate array (FPGA) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interfaces allow for communication between the one or more monitored physical environments 110 and/or the user devices 102 over the network 104, and each illustratively comprises one or more conventional transceivers.

It is to be appreciated that the particular arrangement of elements 112-1, 114-1, 116-1 and 118-1 illustrated in the monitored physical environment 110-1 of the FIG. 1 embodiment is presented by way of example only, and alternative arrangements can be used in other embodiments. For example, the functionality associated with elements 112-1, 114-1, 116-1 and 118-1 in other embodiments can be combined into a single module, or separated across a larger number of elements. As another example, multiple distinct processors can be used to implement different ones of the elements 112-1, 114-1, 116-1 and 118-1 or portions thereof.

At least portions of elements 112-1, 114-1, 116-1 and 118-1 may be implemented at least in part in the form of software that is stored in memory and executed by at least one processor.

It is to be understood that the particular set of elements shown in FIG. 1 for the one or more monitored physical environments 110 and/or user devices 102 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, one or more of the one or more monitored physical environments 110 and at least one associated database can be on and/or part of the same processing platform.

An exemplary process utilizing elements 112-1, 114-1, 116-1 and 118-1 of an example monitored physical environment 110-1 in computer network 100 will be described in more detail with reference to, for example, FIGS. 4, 7 through 9, and/or 11.

FIG. 2 illustrates a monitored physical environment 200 in an illustrative embodiment. As noted above, the monitored physical environment 200 may include one or more sensors 210, a sensor data processing module 215, an anomaly detection module 220 and a mitigation action module 230. The one or more sensors 210 may be embedded in, attached to, or otherwise associated with objects, such as people, materials and equipment (e.g., physical devices).

In some embodiments, the architecture shown in FIG. 2 can correspond to at least a portion of the monitored physical environment 200. By way of example, at least one of the sensors 210, sensor data processing module 215, anomaly detection module 220 and mitigation action module 230 can be implemented within the monitored physical environment 200. In the FIG. 2 embodiment, the sensors 210 may comprise, for example, accelerometers, gyroscopes, cameras, light sensors, humidity sensors, vibration sensors, smoke sensors, door or window open/close sensors, temperature sensors and/or motion sensors. Sensors might be connected, for example, via RFID (radio frequency identifiers), LoRaWAN (long range wide area network), LTE (long-term evolution) or WiFi wireless techniques or using a physical cable. Data read from such sensors may include a sensor identifier and observed data may comprise temperature, motion, light and/or object coordinates, to allow for time of arrival calculations for a precise location of the source of each data reading.

In one or more embodiments, an accelerometer may measure the acceleration force that is applied to a given object using three physical axes (x, y, and z), including the force of gravity. For example, the accelerometer may measure a rate of rotation of the given object in units of radians per second around each of the three physical axes (x, y, and z). A gyroscope may measure an angular velocity (e.g., the change in rotational angle per unit of time) of the given object to determine orientation.

In at least one embodiment, the sensor data processing module 215 transforms the sensor data from the sensors 210 into a format that can be consumed by the anomaly detection module 220 (e.g., by compressing the sensor data and/or reducing noise in the sensor data, as discussed further below). Vibration and pressure are some examples of external disturbances that may cause noise in the sensor data. The anomaly detection module 220, in some embodiments, employs a trained machine learning model that analyzes the sensor data generated by the one or more sensors 210 (and optionally processed by the sensor data processing module 215) and detects potential anomalous behavior with respect to one or more objects in the monitored physical environment 200.

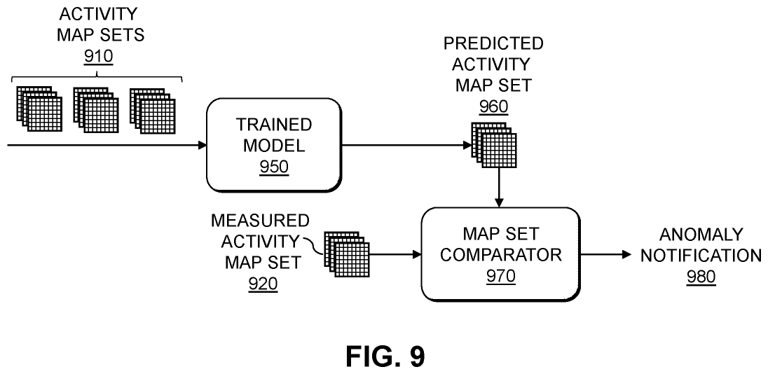

Generally, the anomaly detection module 220 implements one or more trained machine learning processes (and/or models) that are used to detect anomalous behavior with respect to one or more objects, as discussed further below in conjunction with FIG. 9, for example. In at least some embodiments, machine learning refers to a subset of artificial intelligence in the field of computer science that may use statistical techniques to give computers the ability to learn with data, that is, progressively improve performance of one or more particular tasks, without having been explicitly programmed to generate, or perform, the improved tasks.

In some embodiments, a machine learning process, such as a machine learning process based on convolutional neural networks (CNNs), where the anomaly detection module 220 is presented with preprocessed sensor data associated with an expected behavior with respect to one or more objects in the monitored physical environment, and the anomaly detection module 220 learns to detect variations from such sensor data associated with anomalous behavior with respect to the one or more objects, as discussed further below.

In at least some embodiments, the anomaly detection module 220 can implement a process to learn from situations where at least one automated action is initiated in response to a possible anomaly detected using the data from the sensor data processing module 215, and where the anomaly later turns out to be a false positive. In such situations, there are costs associated with implementing the at least one automated action, and also costs associated with returning the system to a normal state of operation. Accordingly, the mitigation action module 230 for selecting and implementing automated actions may provide an automatic mechanism that can identify an acceptable balance between data and/or application availability on the one hand, and the consequences of the speed (e.g., too quickly or too slowly) in which a given automated action is taken on the other hand.

Additionally, in the FIG. 2 embodiment, the mitigation action module 230 includes an event log 235 and alert notification logic 240. The event log 235 can track the anomalies detected by the sensor data processing module 215, any automated actions taken in response to the detected anomalies, and received feedback to such actions. The event log 235 can provide feedback to the anomaly detection module 220 to improve results of the machine learning process, for example.

The alert notification logic 240 may comprise one or more external application programming interface (API) connectors to facilitate a particular automated action. In such embodiments, the APIs can be used to generate notifications for various detected anomalies (e.g., providing at least a portion of the collected sensor data to at least one designated system associated with the monitored physical environment 200). Also, the alert notification logic 240 can provide notifications to a designated device associated with the detected anomaly and/or an external alarm system (not explicitly shown in FIG. 2). For example, the external alarm system may communicate, and operate in connection with various components (e.g., which may or may not be in the computer network 100) to implement, and/or cause the implementation of, one more of the automated actions. Such components, in some embodiments, can include a facilities management system, an operations system, or a local alarm system, as non-limiting examples.

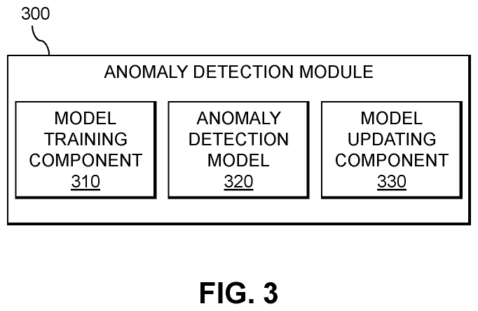

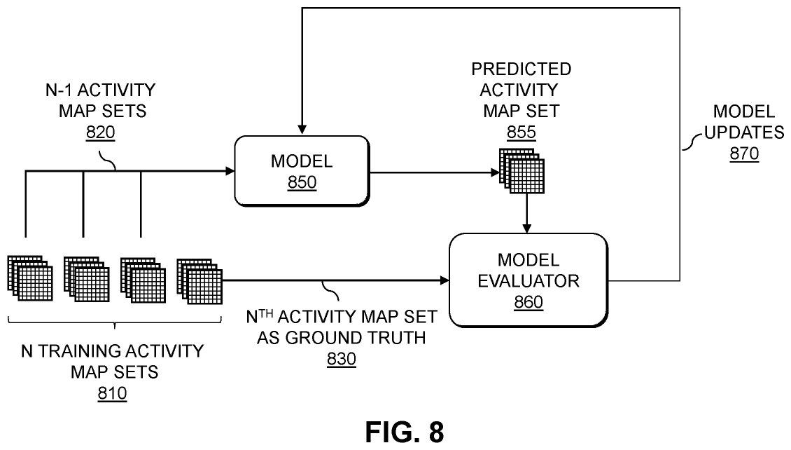

FIG. 3 illustrates an exemplary anomaly detection module 300 in an illustrative embodiment. In the example of FIG. 3, the anomaly detection module 300 comprises a model training component 310, an anomaly detection model 320 and a model updating component 330. The model training component 310 implements a process for training a machine learning model to detect anomalous object behavior in a monitored physical environment, as discussed further below in conjunction with FIG. 8. The anomaly detection model 320, in some embodiments, employs the trained machine learning model that analyzes sensor data generated by one or more sensors and detects potential anomalous behavior with respect to one or more objects in a monitored physical environment, as discussed further below in conjunction with FIG. 9. The model updating component 330 updates the trained machine learning model for example, based on (i) one or more generated error or loss values, or (ii) feedback from a user related to an accuracy of an anomaly notification, as discussed further below.

Referring now to FIG. 4, a process flow diagram is shown of a machine learning process 400 in an illustrative embodiment. The machine learning process 400, in some embodiments, may be operated at least in part using the anomaly detection module 116 of FIG. 1. The process in FIG. 4 includes steps 402-408, although it is to be appreciated that in other embodiments, more, or fewer, steps may be employed. The machine learning process 400, in at least some embodiments, may be performed iteratively, where the time between iterations can be specified (e.g., by a user). In one example embodiment, the time between iterations can be about five minutes, but longer or shorter times may be used.

Step 402 includes obtaining one or more input signals. For example, the one or more input signal may comprise one or more streams of sensor data corresponding to the sensors 210.

Step 404 includes a test to determine whether an anomaly is detected. If an anomaly is detected, then the process continues to step 406, otherwise, the machine learning process 400 returns to step 402.

Step 406 includes identifying and performing one or more recommended actions. For example, step 406 may include identifying the best action out of a set of chosen actions, where the action corresponds to one or more independent variables of a machine learning model (e.g., implemented by anomaly detection module 116). As an example, step 406 can include generating one or more alerts and/or providing at least a subset of the collected sensor data to a designated endpoint for further analysis.

Step 408 is optional and includes obtaining feedback for actions recommended at step 406, which can be used to improve the machine learning model. For example, the feedback can be obtained from an end user on the usefulness or accuracy of the identified recommended actions, such as by rating the ability of the actions to detect, prevent and/or mitigate a detected anomaly.

It is to be appreciated that the feedback provided at step 408 can help provide more effective and efficient results. For example, the feedback can help the machine learning model learn to distinguish between a minor deviation from an expected object behavior and more significant deviations. As the machine learning process progresses, the model may be continuously improved. Thus, the machine learning process may comprise, or consist of, a closed-loop feedback system for continuous improvement of the model.

It is to be further appreciated that this particular process shows just one exemplary implementation of a portion of a machine learning technique, and alternative implementations of the process can be used in other embodiments.

It is noted that the automated actions to mitigate against potential anomalies can include both preemptive actions (e.g., before an anomaly actually impacts a monitored physical environment) and recovery actions (e.g., after an anomaly at least partially affects a monitored physical environment). It is to be understood that such actions can include actions that directly or indirectly affect objects.

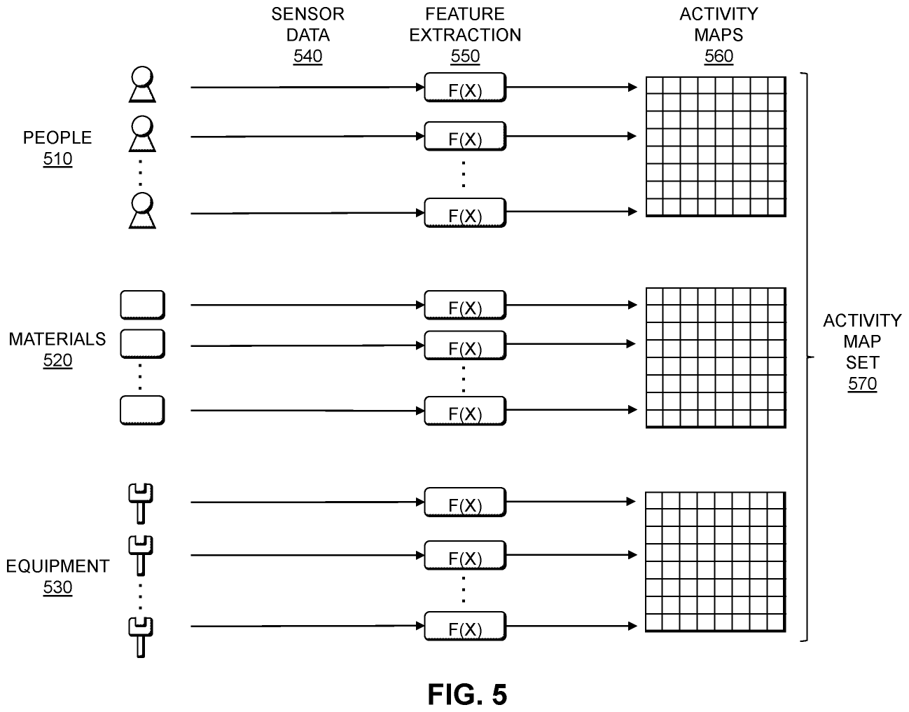

FIG. 5 illustrates a generation of activity maps 560 characterizing sensor data 540 associated with various objects of respective object types (e.g., people 510, materials 520 and equipment 530) in a monitored physical environment in an illustrative embodiment. The set of activity maps 560 of each object type for a given measurement window are referred to herein as an activity map set 570.

In the example of FIG. 5, sensor data 540 is collected from the monitored physical environment (e.g., using sensor data 540 collected from one or more sensors 210 in the monitored physical environment), and one or more feature values (F (X)) are extracted for each object type as part of a feature extraction 550. Separate activity maps 560 may be generated for each object type (e.g., people 510, materials 520 and/or equipment 530). The activity maps 560 may be two or three-dimensional grids over an area of interest, with the cells of each activity map 560 containing data for the objects in the respective cell for each respective object type. For example, the cells may comprise aggregate multivariate data for the objects of each object type in the respective cell. In this manner, the activity maps 560 look at cell-based aggregate data for each object type and provide an indication of what is moving through space in the monitored physical environment without having to track each object through space.

In some embodiments, the raw sensor data, such as acceleration data, gyroscope data, temperature data and/or humidity data for each tracked object may be obtained to compute additional metrics (or model features), during the feature extraction 550, such as velocity and direction of travel of one or more objects of interest. For each object type, a new activity map 560 is created and the following steps are performed for each cell in the respective activity map 560:
identify one or more objects currently within the cell; and
compute aggregated data describing the one or more objects in the cell.
   For example, the aggregated data describing the one or more objects of a given object type in the cell may comprise a number of objects in the cell, an average direction of travel, speed and/or acceleration and a variation in direction, speed and/or acceleration. In addition, the data transformation may comprise scaling recorded data in real-time to determine minimum and maximum values or boundaries for each object and/or each object type; a logarithmic transformation to translate variables into their convex forms for learned modelling, and a Gaussian transformation for probability density calculations based at least in part on object behavior to identify anomalies.

While the exemplary activity maps 560 are shown in FIG. 5 as rectangular shapes, other shapes may be possible, and the activity maps 560 associated with the different object types need not be of the same shape, as would be apparent to a person of ordinary skill in the art. In addition, the cells of the exemplary activity maps 560 may not be equally sized or weighted, such that cells associated with critical areas of the monitored physical environment and/or geographic boundaries may be assigned a higher weight or sensitivity for anomalies, for example.

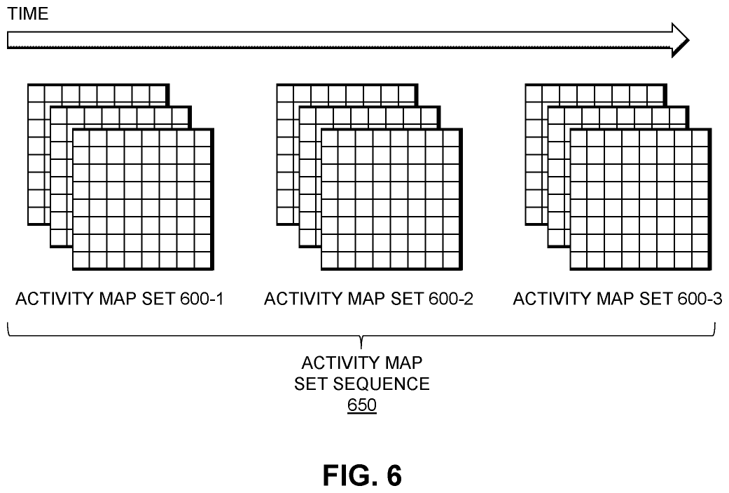

FIG. 6 illustrates an activity map set sequence 650 in an illustrative embodiment. As noted above, the collection of object type-specific activity maps for a given measurement window is hereafter referred to as an activity map set 600. In the example of FIG. 6, the activity map set sequence 650 comprises multiple activity map sets 600-1 through 600-3 over time. For example, in some embodiments, for a given measurement window, the disclosed machine learning-based anomalous object activity detection techniques will produce separate activity maps for each object type (e.g., people, materials and/or equipment) with the cells of each activity map containing the aggregate multivariate data for each object type.

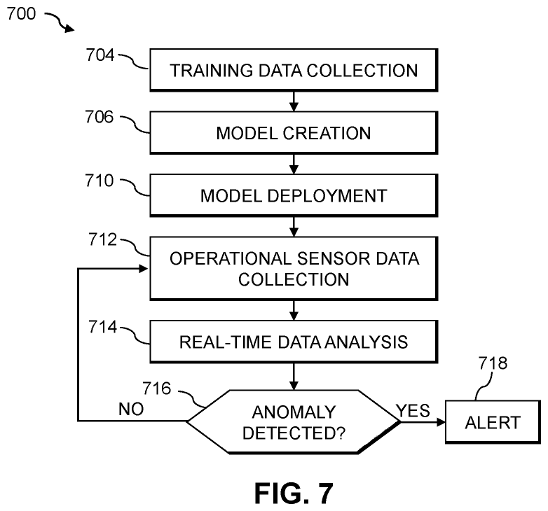

FIG. 7 is a flow diagram illustrating an exemplary implementation of a process 700 for machine learning-based detection of anomalous object behavior in a monitored physical environment, in accordance with an illustrative embodiment. A training portion of the process 700 comprises steps 704 and 706. The training portion may be performed in some embodiments by a training server, such as a local server or an on-cloud server. The trained model is then deployed in step 710 to one or more monitored physical environments and an anomaly detection and mitigation phase is performed, for example, by the anomaly detection module 220 of FIG. 2 in steps 712, 714, 716 and 718.

The training data is collected in step 704. In the example of FIG. 7, the proper sensors to monitor the monitored physical environment may be identified, and the identified sensors may be associated with the objects being monitored to capture the sensor data. Thus, the training data collected in step 704 would be sensor data associated with the particular activity of objects within the monitored physical environment. The raw sensor data is received, for example, by a local training server performing the training, e.g., as a wireless transmission from the one or more sensor devices. Noise may optionally be removed from the sensor data by the local training server before being used for the training process. The training data may comprise sensor data collected from multiple objects of each object type to reduce errors.

The model is created in step 706, for example, by detecting one or more patterns in the sensor data using one or more regression models to obtain weights for the model.

As noted above, the trained model is then deployed in step 710 to one or more monitored physical environments comprising the sensors to monitor the activities of one or more objects of a corresponding object type.

Operational sensor data is collected in step 712 and may be transformed into a format that can be consumed by the anomaly detection module 220 (e.g., by compressing the sensor data and/or reducing noise in the sensor data, as discussed further below). The transformed sensor data is applied to the anomaly detection module 220 of FIG. 2 in step 714, which performs a real-time data analysis by applying the operational sensor data to the trained model to detect any deviations from the learned object behavior.

A test is performed in step 716 to determine if an anomalous object behavior is detected. If it is determined in step 716 that an anomalous object behavior is not detected, then program control returns to step 712 to continue monitoring the real-time sensor data. If, however, it is determined in step 716 that anomalous object behavior is detected, then program control proceeds to step 718 where an alert may be generated (e.g., reporting a deviation from an expected object behavior as one or more potential anomalies) or another automated action may be initiated, for example, by the mitigation action module 230 of FIG. 2.

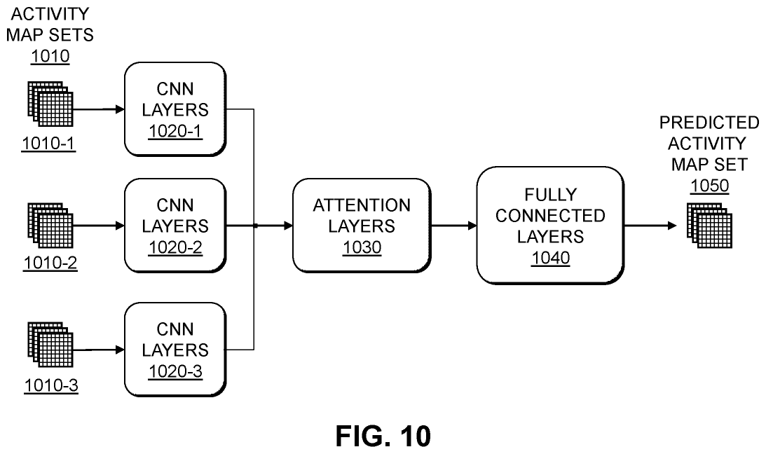

FIG. 8 illustrates a training of a machine learning model to predict activity map sets in an illustrative embodiment. In the example of FIG. 8, N training activity map sets 810 (e.g., activity map sets 600 of FIG. 6) are processed for a given training iteration to train a model 850 (e.g., a machine learning model). N−1 of the activity map sets 820 are used as training data and the N^{th} activity map set 830 is used as ground truth. The N−1 activity map sets 820 are used as the training data to train the model 850 to generate a predicted activity map set 855 (e.g., a prediction of the next activity map set). A representative architecture for the model 850 is discussed further below in conjunction with FIG. 10.

The predicted activity map set 855 (e.g., the prediction of the next activity map set) is compared to the N^{th} activity map set 830 (e.g., the actual next activity map set) by a model evaluator 860. The result of the comparison (e.g., the loss or error of the model 850) is used to adjust one or more parameters (e.g., weights) of the model 850 in the form of model updates 870. In this manner, the selected sequences of N training activity map sets 810 from actual measurements in the monitored physical environment can be directly used to create a training dataset. As a result, localized training techniques can be used to fine-tune models 850 for specific monitored physical environments and re-train a given model 850 in the presence of a model drift.

In this manner, for multiple training iterations, the activity map set sequences 650 of activity map sets 600 from FIG. 6 may be used in some embodiments to train the model 850. In the example of FIG. 8, the training of the model 850 (i) takes, as input, a fixed-length sequence of N training activity map sets 810, (ii) uses N−1 activity map sets 820 (e.g., the N training activity map sets 810 except for the last (e.g., most recent) activity map set) to generate a predicted activity map set 855 (e.g., a prediction of the last activity map set (a prediction of the N^{th} activity map set 830)), and (iii) uses the last activity map set (e.g., the N^{th} activity map set 830) as ground truth to evaluate the generated prediction.

The difference between the predicted activity map set 855 and the corresponding N^{th} activity map set 830 provides an indication of the mismatch between the predicted data and the actual data, referred to as the loss or the error of the model 850. The error of the model 850 is used to adjust one or more parameters (e.g., the weights of one or more layers of the model 850) of the model 850 in the form of the model updates 870 (for example, using back propagation techniques). The trained version of the model 850 is then used in real-time to process N−1 (previous) activity map sets to generate a prediction of the next (e.g., current or N^{th}) activity map set, which can be compared to the actual current activity map set to identify anomalous object behavior, as discussed hereinafter.

FIG. 9 illustrates a detection of anomalous object behavior in a monitored physical environment using a trained machine learning model in an illustrative embodiment. In the example of FIG. 9, a set of activity map sets 910 (e.g., N−1 previous activity map sets) are applied to a trained model 950 (e.g., a trained machine learning model) which generates a predicted activity map set 960 (e.g., a prediction of the N^{th} (next) activity map set).

The predicted activity map set 960 and the corresponding measured activity map set 920 are applied a map set comparator 970 that evaluates the differences (e.g., the mismatch) between the predicted activity map 960 and the measured activity map set 920 provides an indication of differences between the generated predicted data and the actual data, referred to as the error of the trained model 950. The map set comparator 970 detects, for example, abnormal direction, speed, acceleration and/or other cell-based features extracted from the sensor data associated with the monitored physical environment. For each cell of the measured activity map set 920, map set comparator 970 identifies the behavior of any objects that does not match expected object behavior. The map set comparator 970 may employ behavior thresholds based on individual cells and/or behavior thresholds based on localized groups of cells (for example, one or more localized groups of cells associated with an area of the monitored physical environment designated to be of high or critical importance).

When the comparison of the predicted activity map set 960 and the measured activity map set 920 by the map set comparator 970 identifies anomalous object behavior, for example, based on one or more predefined or designated anomalous object behavior criteria, the map set comparator 970 generates one or more anomaly notifications 980, for example, to one or more designated administrators and/or one or more designated systems associated with the monitored physical environment. In some embodiments, the one or more anomaly notifications 980 may comprise at least a portion of the sensor data associated with the measured activity map set 920.

In some embodiments, to reduce false positives, multiple consecutive disagreements between the predicted activity map set 960 and the measured activity map set 920 may be required before indicating the occurrence of an anomalous event.

FIG. 10 illustrates an exemplary architecture for a machine learning model configured to detect anomalous object behavior in a monitored physical environment in an illustrative embodiment. In the example of FIG. 10, the machine learning model processes a fixed number of sequences of activity map sets 1010 separated by object type and generates a predicted activity map set 1050 (e.g., a prediction of a next or current activity map set), as discussed above in conjunction with FIG. 9. For example, the activity map sets 1010 may comprise a sequence of activity map sets 1010-1 of a first object type (e.g., people), a sequence of activity map sets 1010-2 of a second object type (e.g., materials) and a sequence of activity map sets 1010-3 of a third object type (e.g., equipment).

The exemplary machine learning model of FIG. 10 comprises one or more CNN layers 1020-1 through 1020-3, one or more attention layers 1030 and one or more fully connected layers 1040. The machine learning model of FIG. 10 processes the applied activity map set 1010 (e.g., N−1 previous activity map sets).

The one or more CNN layers 1020 examine each input activity map set 1010 and compute learned features that describe the structure of the learned features. The one or more attention layers 1030 look across outputs of the CNN layers 1020 to detect patterns across the sequence of activity map sets 1010. The one or more fully connected layers 1040 use the output of the attention layers 1030 to predict the next activity map set, referred to as the predicted activity map set 1050 in FIG. 10.

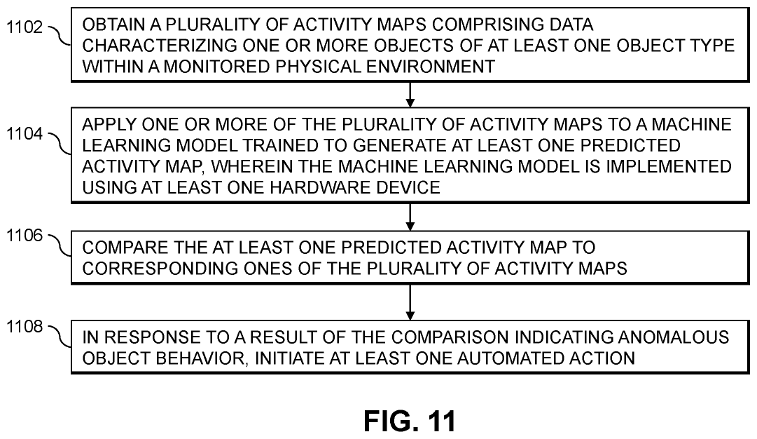

FIG. 11 is a flow diagram illustrating an exemplary implementation of a process for machine learning-based detection of anomalous object behavior in a monitored physical environment, in accordance with an illustrative embodiment. In the example of FIG. 11, a plurality of activity maps comprising data characterizing one or more objects of at least one object type within a monitored physical environment are obtained in step 1102.

In step 1104, one or more of the plurality of activity maps are applied to a machine learning model trained to generate at least one predicted activity map. In at least some embodiments, the machine learning model is implemented using at least one hardware device. As noted above, the term “hardware” may comprise, for example, a processor, a microprocessor, a CPU, a GPU, a TPU, a microcontroller, an ASIC, an FPGA or other type of processing circuitry (or combinations thereof).

The at least one predicted activity map is compared to corresponding ones of the plurality of activity maps in step 1106, and in response to a result of the comparison indicating anomalous object behavior, at least one automated action is initiated in step 1108.

In some embodiments, a given activity map of the plurality of activity maps comprises a plurality of cells, wherein a given cell in the given activity map is mapped to a corresponding portion of the monitored physical environment. The given activity map of the plurality of activity maps may correspond to a particular object type and the given cell of the given activity map may comprise aggregated data characterizing one or more objects of the particular object type in the given cell.

In one or more embodiments, a given activity map of the plurality of activity maps comprises a plurality of features obtained at least in part using sensor data from one or more sensors in the monitored physical environment. The comparing may further comprise identifying one or more disparities between the at least one predicted activity map and the corresponding ones of the plurality of activity maps that represent anomalous object behavior.

In at least some embodiments, the at least one automated action comprises generating an alert and/or providing at least a portion of the sensor data to at least one designated system associated with the monitored physical environment. The machine learning model is trained to generate the at least one predicted activity map using a plurality of historical activity maps, wherein a first subset of the plurality of historical activity maps is used to generate at least one predicted training activity map and wherein one or more parameters of the machine learning model are adjusted based at least in part on a result of a comparison of a second subset of the plurality of historical activity maps to respective ones of the at least one predicted training activity map.

The particular processing operations and other network functionality described in conjunction with FIGS. 4, 7, 8, 9 and 11, for example, are presented by way of illustrative example only, and should not be construed as limiting the scope of the disclosure in any way. Alternative embodiments can use other types of processing operations to provide functionality for machine learning-based detection of anomalous object behavior in a monitored physical environment. For example, the ordering of the process steps may be varied in other embodiments, or certain steps may be performed concurrently with one another rather than serially. In one aspect, the process can skip one or more of the actions. In other aspects, one or more of the actions are performed simultaneously. In some aspects, additional actions can be performed.

It should also be understood that the disclosed techniques for machine learning-based detection of anomalous object behavior in a monitored physical environment can be implemented at least in part in the form of one or more software programs stored in memory and executed by a processor of a processing device such as a computer. As mentioned previously, a memory or other storage device having such program code embodied therein is an example of what is more generally referred to herein as a “computer program product.”

The disclosed techniques for machine learning-based detection of anomalous object behavior in a monitored physical environment may be implemented using one or more processing platforms. One or more of the processing modules or other components may therefore each run on a computer, storage device or other processing platform element. A given such element may be viewed as an example of what is more generally referred to herein as a “processing device.”

As noted above, illustrative embodiments disclosed herein can provide a number of significant advantages relative to conventional arrangements. It is to be appreciated that the particular advantages described above and elsewhere herein are associated with particular illustrative embodiments and need not be present in other embodiments. Also, the particular types of information processing system features and functionality as illustrated and described herein are exemplary only, and numerous other arrangements may be used in other embodiments.

In these and other embodiments, compute services and/or storage services can be offered to cloud infrastructure tenants or other system users as a Platform-as-a-Service (PaaS) model, an Infrastructure-as-a-Service (IaaS) model, a Storage-as-a-Service (STaaS) model and/or a Function-as-a-Service (FaaS) model, although it is to be appreciated that numerous other cloud infrastructure arrangements could be used.

Some illustrative embodiments of a processing platform that may be used to implement at least a portion of an information processing system comprise cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components such as a cloud-based anomalous object behavior detection engine, or portions thereof, are illustratively implemented for use by tenants of such a multi-tenant environment.

Cloud infrastructure as disclosed herein can include cloud-based systems. Virtual machines provided in such systems can be used to implement at least portions of an anomalous object behavior detection platform in illustrative embodiments. The cloud-based systems can include object stores.

In some embodiments, the cloud infrastructure additionally or alternatively comprises a plurality of containers implemented using container host devices. The containers may run on virtual machines in a multi-tenant environment, although other arrangements are possible. The containers may be utilized to implement a variety of different types of functionalities within the storage devices. For example, containers can be used to implement respective processing devices providing compute services of a cloud-based system. Again, containers may be used in combination with other virtualization infrastructure such as virtual machines implemented using a hypervisor.

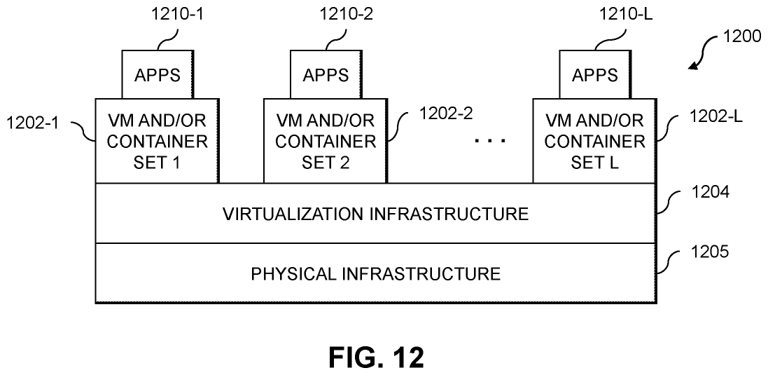

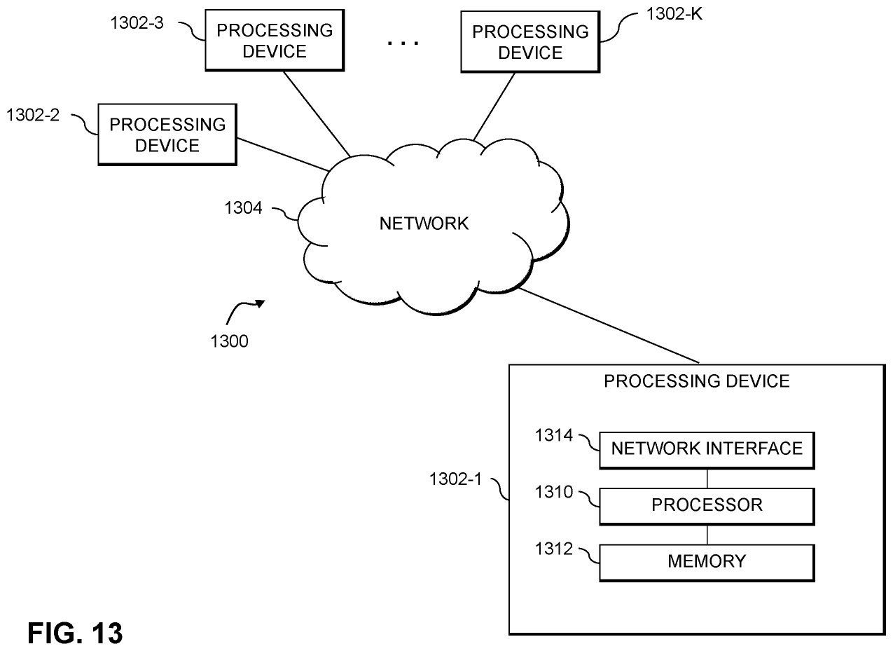

Illustrative embodiments of processing platforms will now be described in greater detail with reference to FIGS. 12 and 13. These platforms may also be used to implement at least portions of other information processing systems in other embodiments.

FIG. 12 shows an example processing platform comprising cloud infrastructure 1200. The cloud infrastructure 1200 comprises a combination of physical and virtual processing resources that may be utilized to implement at least a portion of the information processing system 100. The cloud infrastructure 1200 comprises multiple VMs and/or container sets 1202-1, 1202-2, . . . 1202-L implemented using virtualization infrastructure 1204. The virtualization infrastructure 1204 runs on physical infrastructure 1205, and illustratively comprises one or more hypervisors and/or operating system level virtualization infrastructure. The operating system level virtualization infrastructure illustratively comprises kernel control groups.

The cloud infrastructure 1200 further comprises sets of applications 1210-1, 1210-2, . . . 1210-L running on respective ones of the VMs/container sets 1202-1, 1202-2, . . . 1202-L under the control of the virtualization infrastructure 1204. The VMs/container sets 1202 may comprise respective VMs, respective sets of one or more containers, or respective sets of one or more containers running in VMs.

In some implementations of the FIG. 12 embodiment, the VMs/container sets 1202 comprise respective VMs implemented using virtualization infrastructure 1204 that comprises at least one hypervisor. Such implementations can provide anomalous object behavior detection functionality of the type described above for one or more processes running on a given one of the VMs. For example, each of the VMs can implement anomalous object behavior detection control logic and associated functionality for mitigating detected anomalous object behavior.

A hypervisor may have an associated virtual infrastructure management system. The underlying physical machines may comprise one or more distributed processing platforms that include one or more storage systems.

In other implementations of the FIG. 12 embodiment, the VMs/container sets 1202 comprise respective containers implemented using virtualization infrastructure 1204 that provides operating system level virtualization functionality, such as support for containers running on bare metal hosts, or containers running on VMs. The containers are illustratively implemented using respective kernel control groups of the operating system. Such implementations can provide anomalous object behavior detection functionality of the type described above for one or more processes running on different ones of the containers. For example, a container host device supporting multiple containers of one or more container sets can implement one or more instances of anomalous object behavior detection control logic and associated functionality for mitigating detected anomalous object behavior.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 1200 shown in FIG. 12 may represent at least a portion of one processing platform. Another example of such a processing platform is processing platform 1300 shown in FIG. 13. The processing platform 1300 in this embodiment comprises at least a portion of the given system and includes a plurality of processing devices, denoted 1302-1, 1302-2, 1302-3, . . . 1302-K, which communicate with one another over a network 1304. The network 1304 may comprise any type of network, such as a WAN, a LAN, a satellite network, a telephone or cable network, a cellular network, a wireless network such as WiFi or WiMAX, or various portions or combinations of these and other types of networks. The processing device 1302-1 in the processing platform 1300 comprises a processor 1310 coupled to a memory 1312. The processor 1310 may comprise a microprocessor, a microcontroller, an ASIC, an FPGA or other type of processing circuitry, as well as portions or combinations of such circuitry elements, and the memory 1312, which may be viewed as an example of a “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1302-1 is network interface circuitry 1314, which is used to interface the processing device with the network 1304 and other system components, and may comprise conventional transceivers.

The other processing devices 1302 of the processing platform 1300 are assumed to be configured in a manner similar to that shown for processing device 1302-1 in the figure. Again, the particular processing platform 1300 shown in the figure is presented by way of example only, and the given system may include additional or alternative processing platforms, as well as numerous distinct processing platforms in any combination, with each such platform comprising one or more computers, storage devices or other processing devices.

Multiple elements of an information processing system may be collectively implemented on a common processing platform of the type shown in FIG. 12 or 13, or each such element may be implemented on a separate processing platform.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide containers.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage devices or other components are possible in the information processing system. Such components can communicate with other elements of the information processing system over any type of network or other communication media.

As indicated previously, components of an information processing system as disclosed herein can be implemented at least in part in the form of one or more software programs stored in memory and executed by a processor of a processing device. For example, at least portions of the functionality shown in one or more of the figures are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A method, comprising:
obtaining a plurality of activity maps comprising data characterizing one or more objects of at least one object type within a monitored physical environment;
applying one or more of the plurality of activity maps to a machine learning model trained to generate at least one predicted activity map, wherein the machine learning model is implemented using at least one hardware device;
comparing the at least one predicted activity map to corresponding ones of the plurality of activity maps; and
in response to a result of the comparison indicating anomalous object behavior, initiating at least one automated action;
wherein the method is performed by at least one processing device comprising a processor coupled to a memory.

2. The method of claim 1, wherein a given activity map of the plurality of activity maps comprises a plurality of cells, wherein a given cell in the given activity map is mapped to a corresponding portion of the monitored physical environment.

3. The method of claim 2, wherein the given activity map of the plurality of activity maps corresponds to a particular object type and wherein the given cell of the given activity map comprises aggregated data characterizing one or more objects of the particular object type in the given cell.

4. The method of claim 1, wherein a given activity map of the plurality of activity maps comprises a plurality of features obtained at least in part using sensor data from one or more sensors in the monitored physical environment.

5. The method of claim 1, wherein the at least one automated action comprises one or more of generating an alert and providing at least a portion of the data characterizing the one or more objects of the at least one object type within the monitored physical environment to at least one designated system associated with the monitored physical environment.

6. The method of claim 1, wherein the machine learning model is trained to generate the at least one predicted activity map using a plurality of historical activity maps, wherein a first subset of the plurality of historical activity maps is used to generate at least one predicted training activity map and wherein one or more parameters of the machine learning model are adjusted based at least in part on a result of a comparison of a second subset of the plurality of historical activity maps to respective ones of the at least one predicted training activity map.

7. The method of claim 1, wherein the comparing further comprises identifying one or more disparities between the at least one predicted activity map and the corresponding ones of the plurality of activity maps that represent anomalous object behavior.

8. A non-transitory processor-readable storage medium having stored therein program code of one or more software programs, wherein the program code when executed by at least one processing device causes the at least one processing device to perform the following steps:
obtaining a plurality of activity maps comprising data characterizing one or more objects of at least one object type within a monitored physical environment;
applying one or more of the plurality of activity maps to a machine learning model trained to generate at least one predicted activity map, wherein the machine learning model is implemented using at least one hardware device;
comparing the at least one predicted activity map to corresponding ones of the plurality of activity maps; and
in response to a result of the comparison indicating anomalous object behavior, initiating at least one automated action.

9. The non-transitory processor-readable storage medium of claim 8, wherein a given activity map of the plurality of activity maps comprises a plurality of cells, wherein a given cell in the given activity map is mapped to a corresponding portion of the monitored physical environment.

10. The non-transitory processor-readable storage medium of claim 9, wherein the given activity map of the plurality of activity maps corresponds to a particular object type and wherein the given cell of the given activity map comprises aggregated data characterizing one or more objects of the particular object type in the given cell.

11. The non-transitory processor-readable storage medium of claim 8, wherein a given activity map of the plurality of activity maps comprises a plurality of features obtained at least in part using sensor data from one or more sensors in the monitored physical environment.

12. The non-transitory processor-readable storage medium of claim 8, wherein the at least one automated action comprises one or more of generating an alert and providing at least a portion of the data characterizing the one or more objects of the at least one object type within the monitored physical environment to at least one designated system associated with the monitored physical environment.

13. The non-transitory processor-readable storage medium of claim 8, wherein the machine learning model is trained to generate the at least one predicted activity map using a plurality of historical activity maps, wherein a first subset of the plurality of historical activity maps is used to generate at least one predicted training activity map and wherein one or more parameters of the machine learning model are adjusted based at least in part on a result of a comparison of a second subset of the plurality of historical activity maps to respective ones of the at least one predicted training activity map.

14. The non-transitory processor-readable storage medium of claim 8, wherein the comparing further comprises identifying one or more disparities between the at least one predicted activity map and the corresponding ones of the plurality of activity maps that represent anomalous object behavior.

15. An apparatus comprising:
at least one processing device comprising a processor coupled to a memory;
the at least one processing device being configured to implement the following steps:
obtaining a plurality of activity maps comprising data characterizing one or more objects of at least one object type within a monitored physical environment;
applying one or more of the plurality of activity maps to a machine learning model trained to generate at least one predicted activity map, wherein the machine learning model is implemented using at least one hardware device;
comparing the at least one predicted activity map to corresponding ones of the plurality of activity maps; and
in response to a result of the comparison indicating anomalous object behavior, initiating at least one automated action.

16. The apparatus of claim 15, wherein a given activity map of the plurality of activity maps comprises a plurality of cells, wherein a given cell in the given activity map is mapped to a corresponding portion of the monitored physical environment, and wherein the given activity map of the plurality of activity maps corresponds to a particular object type and wherein the given cell of the given activity map comprises aggregated data characterizing one or more objects of the particular object type in the given cell.

17. The apparatus of claim 15, wherein a given activity map of the plurality of activity maps comprises a plurality of features obtained at least in part using sensor data from one or more sensors in the monitored physical environment.

18. The apparatus of claim 15, wherein the at least one automated action comprises one or more of generating an alert and providing at least a portion of the data characterizing the one or more objects of the at least one object type within the monitored physical environment to at least one designated system associated with the monitored physical environment.

19. The apparatus of claim 15, wherein the machine learning model is trained to generate the at least one predicted activity map using a plurality of historical activity maps, wherein a first subset of the plurality of historical activity maps is used to generate at least one predicted training activity map and wherein one or more parameters of the machine learning model are adjusted based at least in part on a result of a comparison of a second subset of the plurality of historical activity maps to respective ones of the at least one predicted training activity map.

20. The apparatus of claim 15, wherein the comparing further comprises identifying one or more disparities between the at least one predicted activity map and the corresponding ones of the plurality of activity maps that represent anomalous object behavior.
